(19) United States
(12) Patent Application Publication
(10) Pub. No.: US 2022/0225007 A1
(43) Pub. Date: Jul. 14, 2022

(54) Headphones

(71) Applicant: Hewlett-Packard Development Company, L.P., Spring, TX (US)

(72) Inventors: Dimitre D. Mehandjiysky, Spring, TX (US); Syed S. Azam, Spring, TX (US); Alexander Williams, Spring, TX (US)

(73) Assignee: Hewlett-Packard Development Company, L.P., Spring, TX (US)

(21) Appl. No.: 17/442,966

(22) PCT Filed: Jul. 22, 2019
(86) PCT No.: PCT/US2019/042849

§ 371 Date: Sep. 24, 2021

(51) Int. Cl. H04R 1/10; G10L 17/22; G10L 17/06; G06V 40/13; G06V 40/12; G06F 21/32; A63F 13/25; F21V 33/00

(52) U.S. Cl. CPC H04R 1/1041; G10L 17/22; G10L 17/06; G06V 40/13; F21V 33/0056; H04R 1/1008; G06F 21/32; A63F 13/25; G06V 40/1365

(57) ABSTRACT

A system, method, and apparatus for modifying the state of headphones is disclosed. For example, a system may include a pair of headphones in a first state and a headphone assembly physically connecting the pair of headphones. The system may include a biometric sensor located on the headphone assembly. The system may also include a local authenticator located in the pair of headphones to switch the headphones to a second state in response to a user providing authentication to the pair of headphones by interacting with the biometric sensor.

### BACKGROUND

Headphones deliver sound to a user from a source. The sound source can be a computer, a mobile device, a laptop, a wearable, or from a more remote location such as a web server. Some headphones are locally powered through batteries and other headphones use power transmitted to them through a wire. The wire for power may be the same as a wire for sound delivery. Wireless headphones may be battery powered and the batteries may be replaced and in some instances the batteries may be rechargeable either by a wire or wirelessly.

### BRIEF DESCRIPTION OF THE DRAWINGS

Certain examples are described in the following detailed description and in reference to the drawings, in which:

FIG. 1 is a block diagram of an example pair of headphones for authenticating a user.

FIG. 2 is a block diagram for an example system for headphone authentication showing the location of the authenticator.

FIG. 3 is a block diagram for an example pair of headphones for adjusting a number of user specific headphone settings.

FIG. 4 is a schematic diagram for an example authentication system for headphone authentication showing data flow through an example authentication system.

FIG. 5 is a flow diagram of an example method for modifying the state of a pair of headphones.

FIG. 6 is a block diagram of a computer readable medium including instructions for modifying the state of a pair of headphones.

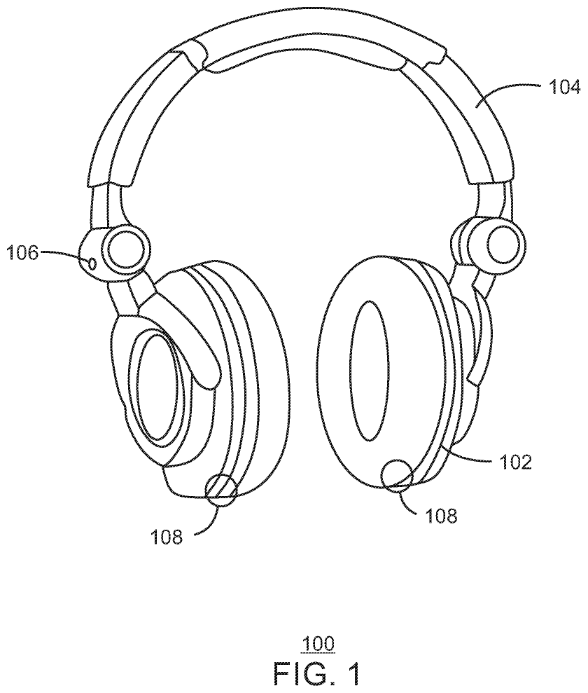

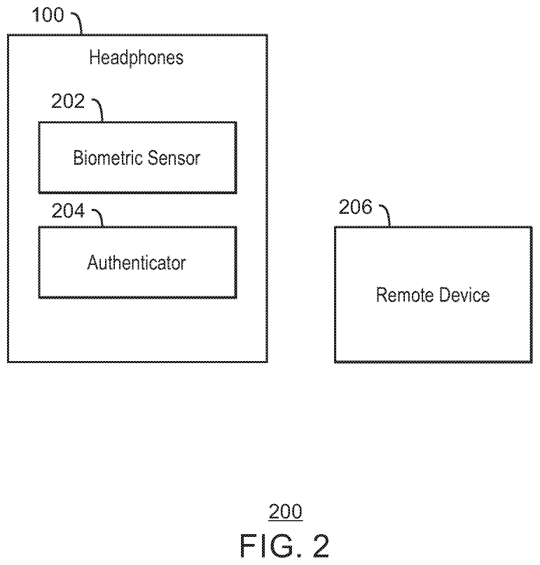

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

The present disclosure relates to switching the state of headphones. This can include switching from a locked to an unlocked state, powering on from a powered off state, or adjusting the headphones to specific pre-set settings. The techniques described herein may also enable the headphones to be the point of authentication for game files, character profiles, and other log-ins on devices that are separate from the headphones.

In general, the techniques described here refer to headphones with a biometric sensor and the ability to locally authenticate input from a user on the biometric sensor. The biometric sensor may be combined with a power on and off button so that the physical movement of the button turns on the power while, at the same time, gathering biometric input from a user such as a fingerprint. Doing both of these actions at the same time using the same physical component reduces the amount of hardware a user operates while preserving the functionality to both turn off and on a device and confirm a user is authorized. There are many possible variations including using the authentication itself with no physically moving switch in order to power on the headphones for a specific user individually. The authentication may be linked to retrieving specific data for the user such as a game file or a user profile on a device. The biometric sensor may focus on identification instead or in addition to authentication. Identification of a user by biometric input retrieved by the biometric sensor may allow the headphones to adjust to a user specific setting. These settings can be light setting or sound settings, such as adjusting an equalizer to a specific setting pre-set by or for that specific user. Each of these examples are a general illustration and many other possible variations utilizing the disclosed techniques are possible. The following figures and description likewise are simplified. Many components may be omitted to aid in discussion.

FIG. 1 is a block diagram of an example pair of headphones 100 for authenticating a user. Each headphone 102 in the pair of headphones 100 can be connected by a headphone assembly 104. In an example the headphone assembly is a physical band that goes over the head of a user. The headphone assembly 104 may go behind the head of the user. Other physical connection styles for the headphone assembly are possible.

The pair of headphones 100 include a fingerprint reader 106 located in the headphone assembly 104. The fingerprint reader 106 may be located in any portion of the headphone assembly 104 including joints or connection pieces to each headphone 102. In an example, the fingerprint reader 106 may be on the body of the headphone 100. The fingerprint reader 106 may be based on contact or may be based on imaging or any other fingerprint reading technique.

The pair of headphones 100 may include a voice identifier 108. The voice identifier 108 may be a microphone or other component that detects the soundwaves generated by the user. In an example, the voice identifier 108 may be located in one or both of the pair of headphones 100. The voice identifier 108 may be located towards the bottom of the headphone 102 in order to be closer to the mouth of a user.

FIG. 2 is a block diagram for an example system for headphone authentication 200 showing the location of a biometric sensor 202 and the authenticator 204. Like numbered items are as described above with respect to FIG. 1.

The biometric sensor 202 is located in or on the pair of headphones 100. The biometric sensor 202 may include a fingerprint reader 106. The biometric sensor 202 may include the voice identifier 108. The biometric sensor 202 may measure other types of data from a user. The data received at the biometric sensor may be passed to the authenticator 204 for authentication. The authenticator 204 is located on or in the pair of headphones 100. The authentication 204 may occur within the pair of headphones 100 without reference to a remote device 206. As used herein, a remote device 206 is physically distinct from the pair of headphones 100. As used herein, a remote device 206 may accessible to the pair of headphones 100 via a wireless communication protocol. As used herein, the biometric sensor 202 and the authenticator 204 are both located on or in the pair of headphones 100 and may authenticate a user without use or communication to a remote device 206.

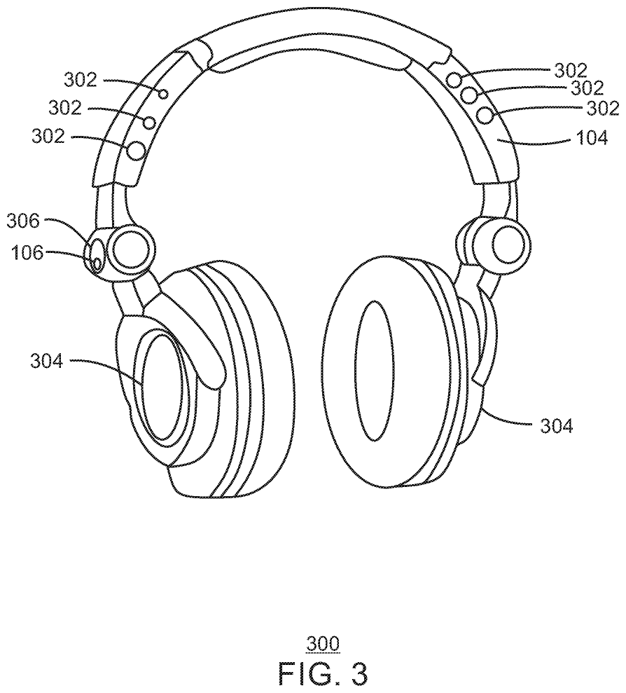

FIG. 3 is a block diagram for an example pair of headphones for adjusting a number of user specific headphone settings 300. Like numbered items are described with respect to FIG. 1.

The headphone assembly 104 includes a number of lights 302 that may be illuminated for decorative or visibility reasons. The exact color, brightness, and shape of each of these lights may be adjusted by a user and saved as a lighting profile. In response to a user authorization or identification, the number of lights 302 may adjust themselves from a first state to a second state where the light setting by the user is activated. In an example, the number of lights 302 may react to an incorrect authorization attempt by blinking or changing color to notify the user to try again. In an example, the number of lights 302 may be located in any location on the pair of headphones 100. In an example, the number of lights 302 may be a single light source with a number of lighting abilities.

In an example, the pair of headphones 100 includes an equalizer 304 located local to the pair of headphones 100. The location of the equalizer 304 may also be in a remote device. The equalizer 304 may adjust sound settings for playback to a user. The equalizer may have a number of preset settings saved to correspond to a specific user or a default user. In an example, a pair of headphones may be in a first state with a default equalizer setting and in response to a user interaction with the fingerprint reader 106, the equalizer 304 may modify the headphones to a second state where the equalizer 304 sets the sound settings to the pre-sets of the user.

The fingerprint reader 106 shown in FIG. 3 is a movable switch that may move within a movement track 306 located on the headphone assembly 104. In an example, the movement track 306 may be located on a headphone 102 instead of the headphone assembly 104. In an example, the pair of headphones 102 may be modified from a first state of being powered off to a second state of being powered on in response to a user interaction with the fingerprint reader 106 sliding it to an on position. At the same time, the pair of headphones 100 may also be modified from a first state of locked to a second state of unlocked, in response to a confirmation that the user moving the fingerprint reader 106 is authorized to user the pair of headphones 100. This authorization is determined locally on the pair of headphones 100 using data from a biometric sensor such as the fingerprint reader 106.

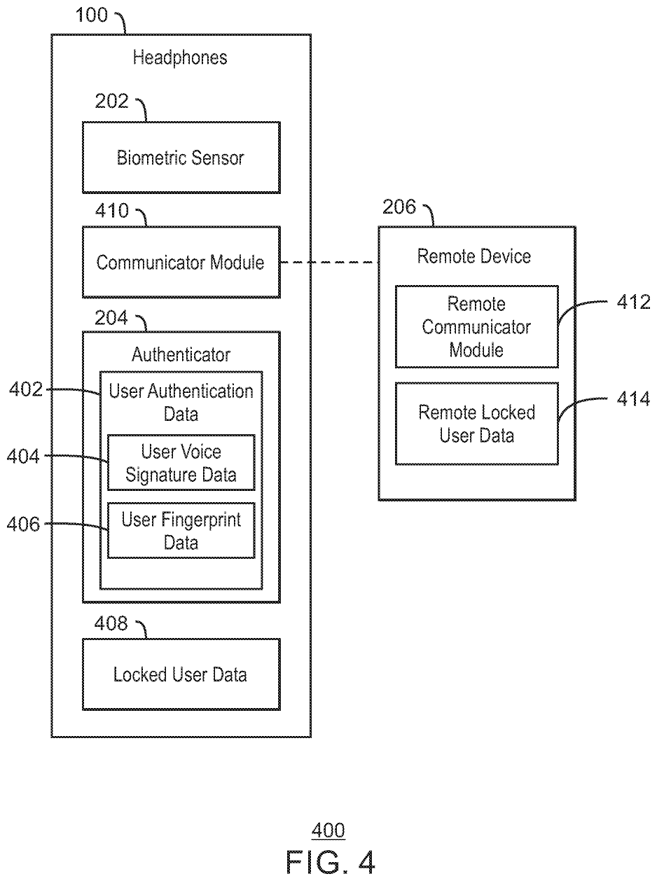

FIG. 4 is a schematic diagram for an example authentication system for headphone authentication 400 showing data flow through an example authentication system. Like numbered items are as described above with respect to FIGS. 1 and 2.

The authenticator 204 located on the pair of headphones 100 may include user authentication data 402. The user authentication data 402 may include user voice signature data 404. The user authentication data 402 may include user fingerprint data 406 also called a match. In an example, a match may be user authentication that includes fingerprint data as well as additional user identifying information such as user specific biometrics. The user voice signature data 404 may be a pre-recording of a user voice sample that is in its original state or modified to include a subset of utterances or information about the voice of the user.

The pair of headphones 100 may also include locked users data 408. This locked user data could be a save file for a video game, a number of passwords, a user profile for an online account, or other type of user specific data. In video games for example, save files or user profiles can be valuable monetarily through the sponsorships and following that particular profile has amassed. In an example, save files or user profiles can be valuable as they are associated with a collection of digital items or currency that are valuable to other players and thus keeping access restricted enables a higher level of security for these items of value. In an example, save files or user profiles can be emotionally valuable and users may store them for particular voice and video playback, the chat or voice logs associated with those profiles, or other meaningful pieces of a digital identity of a user. Locked user data 408 may also be a proof of purchase of the pair of headphones 100 that can be linked back the physical identity of a user rather than the digital identity of the user. In an example, the locked user data 408 may be voice recording files that include voice recordings of the user used to generate a vocal signature.

The pair of headphones 100 may wish to access data from a remote device 206. The pair of headphones may include a communicator module 410 in order to communicate with the remote communicator module 412 of the remote device 206. The remote device 206 may include remote locked user data 412. In an example, the pair of headphones may first authenticate the user and then provide an indication to the remote device 206 of the user authorization to access the remote locked user data 414. This process may include a secure handshake, an exchange of authentication tokens or other means of encrypted exchange of user authorization to access the remote locked user data 414.

In an example, the remote device 206 may be a laptop or a video game system and rather than logging in to the remote device 206 directly, the user may authenticate themselves using the biometric sensor 202 on the pair of headphones 100. The pair of headphones may then communicate the authorization of the user to access the remote device 206 to the remote device 206. This reduces the number of logins and may shift a login location to a place closer to the user. In some cases the headphones may not work unless a user has provided biometric input to satisfy the authenticator 204. In an example where the pair of headphones 100 or the remote device include a number of user profiles, a user identification may be performed where a specific user profile is loaded and enacted based on the user identification.

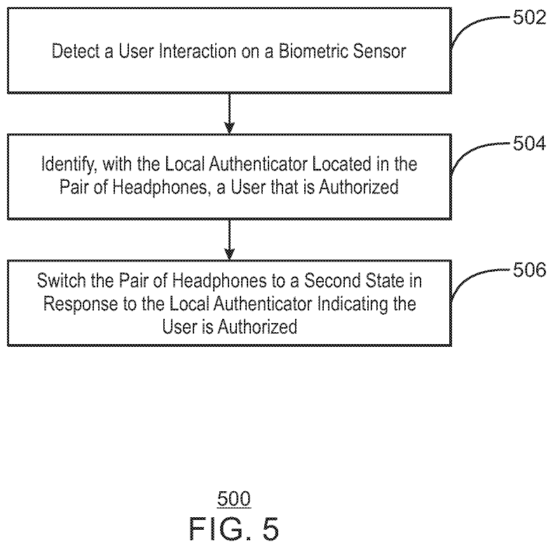

FIG. 5 is a flow diagram of an example method for modifying the state of a pair of headphones. The method 500 may be implemented on a number of different systems or devices including those shown in FIGS. 1, 2, 3, 4, and 6.

At block 502, the method 500 includes detecting a user interaction on a biometric sensor located on a headphone assembly physically connecting a pair of headphones in a first state. At block 504, the method 500 includes identifying, with the local authenticator located in the pair of headphones, a user that is authorized in response to a comparison of the user interaction on the biometric sensor with a user profile stored and accessed in the pair of headphones. In an example, the biometric sensor is at least one of a fingerprint or a microphone coupled to a voice recognition module local to the pair of headphones with no voice data for an initial authentication is sent to a remote device from the pair of headphones. In an example, the local authenticator comprises voice recognition that reverts the pair of headphones from a second state to a first state in response to detecting a voice that does not belong to the user at the biometric sensor.

At block 506, the method 500 includes switching the pair of headphones to a second state in response to the local authenticator indicating the user is authorized. In an example, in response to the user providing authentication, the local authenticator provides a token that both identifies the user providing the authentication and provides credentials authenticating the user to a remote system connected to the pair of headphones. In an example, the local authenticator unlocks at least one of a game save file belonging to the user or a video game character profile belonging to the user in response to the user providing authentication to the pair of headphones by interacting with the biometric sensor. In an example, the second state corresponds to a sound output equalizer setting matching a previous sound output equalizer setting made by the user.

In an example, the first state is a power off state and the second state is a power on state. One specific implementation includes the biometric sensor as both a physically movable power switch and a fingerprint reader. In this example, the pair of headphones is powered on in response to the user moving the biometric sensor into an on position. Further, in this example the biometric sensor detects a user fingerprint for authentication.

In an example, a plurality of lights physically mounted on at least one of the pair of headphones or the headphone assembly. In this example, the first state is a first lighting configuration and the second state is a second lighting configuration. In an example, the local authenticator located in the pair of headphones is to switch the headphones to a third state corresponding to information from a second user in response to the second user providing authentication to the pair of headphones by interacting with the biometric sensor.

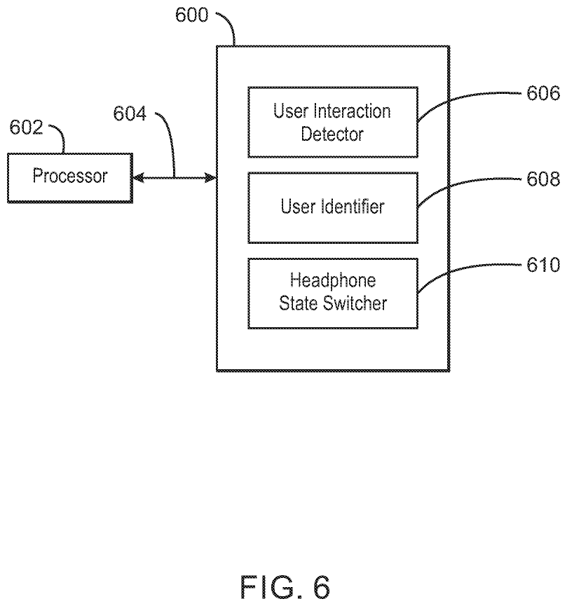

FIG. 6 is a block diagram of a computer readable medium 600 including instructions for modifying the state of a pair of headphones. A processor 602 may be used to execute instructions provided to it over a bus 604 from the computer readable medium 600.

The computer readable medium 600 may include a user interaction detector 606. In an example, the user interaction detector 606 detects a user interaction on a biometric sensor located on a headphone assembly physically connecting a pair of headphones in a first state. The computer readable medium 600 may also include a user identifier 608. In an example, the user identifier 608 identifies with the local authenticator located in the pair of headphones that a user is authorized in response to a comparison of the user interaction on the biometric sensor with a user profile stored and accessed in the pair of headphones. In an example, the biometric sensor is at least one of a fingerprint or a microphone coupled to a voice recognition module local to the pair of headphones with no voice data for an initial authentication is sent to a remote device from the pair of headphones. In an example, the local authenticator comprises voice recognition that reverts the pair of headphones from a second state to a first state in response to detecting a voice that does not belong to the user at the biometric sensor.

The computer readable medium 600 may include a headphone state switcher 610. In an example, the headphone state switcher 610 switches the pair of headphones to a second state in response to the local authenticator indicating the user is authorized. In an example, in response to the user providing authentication, the local authenticator provides a token that both identifies the user providing the authentication and provides credentials authenticating the user to a remote system connected to the pair of headphones. In an example, the local authenticator unlocks at least one of a game save file belonging to the user or a video game character profile belonging to the user in response to the user providing authentication to the pair of headphones by interacting with the biometric sensor. In an example, the second state corresponds to a sound output equalizer setting matching a previous sound output equalizer setting made by the user.

In an example, the first state is a power off state and the second state is a power on state. One specific implementation includes the biometric sensor as both a physically movable power switch and a fingerprint reader. In this example, the pair of headphones is powered on in response to the user moving the biometric sensor into an on position. Further, in this example the biometric sensor detects a user fingerprint for authentication.

In an example, a plurality of lights physically mounted on at least one of the pair of headphones or the headphone assembly. In this example, the first state is a first lighting configuration and the second state is a second lighting configuration. In an example, the local authenticator located in the pair of headphones is to switch the headphones to a third state corresponding to information from a second user in response to the second user providing authentication to the pair of headphones by interacting with the biometric sensor.

1. A system for modifying a state of headphones, comprising:
a pair of headphones in a first state;
a headphone assembly physically connecting the pair of headphones;
a biometric sensor located on the headphone assembly; and
a local authenticator located in the pair of headphones to switch the headphones to a second state in response to a user providing authentication to the pair of headphones by interacting with the biometric sensor.

2. The system of claim 1, wherein the first state is a power off state and the second state is a power on state.

3. The system of claim 1, wherein the biometric sensor is at least one of a fingerprint or a microphone coupled to a voice recognition module local to the pair of headphones with no voice data for an initial authentication is sent to a remote device from the pair of headphones.

4. The system of claim 1, where in response to the user providing authentication, the local authenticator provides a token that both identifies the user providing the authentication and provides credentials authenticating the user to a remote system connected to the pair of headphones.

5. The system of claim 1, wherein the local authenticator comprises voice recognition that reverts the pair of headphones from a second state to a first state in response to detecting a voice that does not belong to the user at the biometric sensor.

6. The system of claim 1, wherein the local authenticator unlocks at least one of a game save file belonging to the user or a video game character profile belonging to the user in response to the user providing authentication to the pair of headphones by interacting with the biometric sensor.

7. The system of claim 1, wherein:
the biometric sensor is both a physically movable power switch and a fingerprint reader;
the pair of headphones is powered on in response to the user moving the biometric sensor into an on position; and
the biometric sensor detects a user fingerprint for authentication.

8. The system of claim 1, wherein the second state corresponds to a sound output equalizer setting matching a previous sound output equalizer setting made by the user.

9. The system of claim 1, comprising:
a plurality of lights physically mounted on at least one of the pair of headphones or the headphone assembly;
wherein the first state is a first lighting configuration; and
wherein the second state is a second lighting configuration.

10. The system of claim 1, wherein the local authenticator located in the pair of headphones to switch the headphones to a third state corresponding to information from a second user in response to the second user providing authentication to the pair of headphones by interacting with the biometric sensor.

11. A method for modifying a state of headphones, comprising:
detecting a user interaction on a biometric sensor located on a headphone assembly physically connecting a pair of headphones in a first state;
identifying, with a local authenticator located in the pair of headphones, a user that is authorized in response to a comparison of the user interaction on the biometric sensor with a user profile stored and accessed in the pair of headphones; and
switching the pair of headphones to a second state in response to the local authenticator indicating the user is authorized.

12. The method of claim 11, wherein the first state is a power off state and the second state is a power on state.

13. The method of claim 11, wherein the biometric sensor is at least one of a fingerprint or a microphone coupled to a voice recognition module local to the pair of headphones such that no voice data for an initial authentication is sent to a remote device from the pair of headphones.

14. The method of claim 11, where in response to the user providing authentication, the local authenticator provides a token that both identifies the user providing the authentication and provides credentials authenticating the user to a remote system connected to the pair of headphones.

15. A computer-readable medium comprising a processor and a memory to store instructions that when executed on the processor cause the processor to:
detect a user interaction on a biometric sensor located on a headphone assembly physically connecting a pair of headphones in a first state;
identify with a local authenticator located in the pair of headphones that a user is authorized in response to a comparison of the user interaction on the biometric sensor with a user profile stored and accessed in the pair of headphones; and
switch the pair of headphones to a second state in response to the local authenticator indicating the user is authorized.
